(19) United States
(12) Patent Application Publication
(10) Pub. No.: US 2012/0186719 A1
(43) Pub. Date: Jul. 26, 2012

(54) Method For Performing An Ultrasonic Welding Process On At Least One Web

(75) Inventor: Martinus Cornelus Adrianus Van Den Aker, Tilburg (NL)

(73) Assignee: BEILER BEHEER B.V., TILBURG (NL)

(21) Appl. No.: 13/389,248

(22) PCT Filed: Jul. 16, 2010
(86) PCT No.: PCT/NL10/00116

§ 371 Date: Apr. 17, 2012

(30) Foreign Application Priority Data
Aug. 7, 2009 (NL) 1037184

(51) Int. Cl. B32B 37/10; B32B 41/00; B32B 38/18

(52) U.S. Cl. 156/73.1; 156/538; 156/350

(57) ABSTRACT

In a device (10) which is adapted to perform an ultrasonic welding process on at least one web (8, 9) by means of an elongated welding combination (4), i.e. a combination of an elongated welding head (1) and an elongated anvil element, the welding combination (4) is movably arranged, and means (12) for realizing a displacement of the welding combination (4) are provided. The welding combination (4) may be displaceable in a direction (C) which is perpendicular to a direction (W) of conveyance of the web (8, 9) through the device (10). During the displacement process, the displacements of both the welding head (1) and the anvil element are accurately controlled, so that the mutual positioning of these components of the welding combination (4) is maintained. Due to the displaceable arrangement of the welding combination (4), there is no limit to a width of webs (8, 9) to be treated.

The invention relates to a method for performing an ultrasonic welding process on at least one web, wherein a device comprising a combination of elongated welding head and an elongated anvil element is applied, wherein the web is positioned between the welding head and the anvil element, wherein an ultrasonic vibrating movement of the welding head is realized while the welding head and the anvil element are in an effective mutual position for performing the ultrasonic welding process, and wherein a relative movement of the web on the one hand and the combination of the welding head and the anvil element on the other hand is realized.

Furthermore, the invention relates to a device for performing an ultrasonic welding process on at least one web, comprising a combination of welding head and an anvil element, and means for realizing an ultrasonic vibrating movement of the welding head.

A method and a device as mentioned in the foregoing are known. For example, WO 95/13182 discloses an ultrasonic welding arrangement including an ultrasonic welding unit which is comprised of an electric high-frequency generator, a transducer which converts the high-frequency electrical energy to mechanical energy, an amplifier which increases the amplitude of the mechanical oscillations, and a welding head which is connected to the amplifier such that its mechanical oscillations are transmitted to the welding head in the form of reciprocating motion. Furthermore, the arrangement includes an anvil roller on whose peripheral surface anvils in the form of projections are disposed in a chosen pattern, and transport means which function to move webs to be joined together through a nip or gap defined by the periphery of the anvil roller and an end of the welding head.

During operation of the known ultrasonic welding arrangement, the webs are made to travel through the nip or gap as mentioned in the foregoing, and the anvil roller is rotated at a speed which coincides with the speed at which the webs are travelling. Furthermore, the welding head is made to move up and down in the material of the webs with a frequency that lies within the ultrasonic range. As a result of this process, which is a mechanical working process, heat is generated in the material, causing it to melt. Hence, materials located in between welding head and anvil roller melt and therewith fuse together. Materials which are suitable to be joined by means of an ultrasonic welding process include thermoplastic materials such as polypropylene.

In the ultrasonic welding process, it is important that the welding head and the anvil roller cooperate in the most accurate manner, wherein the actual welding process takes place at small contact surfaces between an end of the welding head and anvils of the anvil roller. This fact is one of the reasons why there is a limit to the width of ultrasonic welding devices in practice, besides the fact that it is not practical to have a large and heavy welding head that still needs to be driven such as to perform an ultrasonic vibrating movement.

There have been experiments in which the welding head was equipped with a number of more or less separate head units, wherein the head units were combined with a long anvil roller, and wherein the head units were arranged next to each other in a row, but these experiments only proved that expensive and inconvenient devices could be obtained in this way. For example, ten head units having a width of 270 mm were used, or nine head units having a width of 300 mm. In fact, currently available ultrasonic welding devices have a maximum width of about 2.70 metres, and the ultrasonic welding process cannot be used for treating a web which is having a larger width. Since there is a need for subjecting webs to an ultrasonic welding process which are having a width of 6, 8, or even 10 metres, there is a problem that a width limitation exists. It is an objective of the invention to provide a solution to this problem. To this end, the invention provides a method according to which a combination of elongated welding head and an elongated anvil element is moved in the device during the ultrasonic welding process, in a direction which is different from the direction in which the ultrasonic vibrating movement of the welding head takes place, wherein the effective mutual position of the welding head and the anvil element is maintained at the same time. In other words, according to the invention, the welding head and the anvil element are kept at the same mutual position as in a conventional device, in order to have a proper ultrasonic welding process, wherein the difference with respect to the conventional situation resides in the fact that the welding head and the anvil element are also moved as a combination through the device. According to the state of the art, the welding head and the anvil element are located at a fixed position in the device, but this is not the case when the invention is applied. It is an achievement of the invention that the traditional insight that the welding head and the anvil element cannot be displaced in the device is abandoned.

The traditional insight is based on the idea that it is practically impossible to move an elongated welding head and an elongated anvil element as a combination through the welding device, in such a way that the accurate mutual positioning of the welding head and the anvil element that is needed for a correct realization of a welding process is maintained. The main reason for this idea is the fact that the welding head and the anvil element are separated from each other by the at least one web to be treated. Among other things, the invention is based on the insight that it is possible to subject at least one web to ultrasonic welding without a direct physical connection between the welding head and the anvil element.

In the following description of the invention, the combination of the welding head and the anvil element will be referred to as welding combination. When the method according to the invention is applied, there is no longer a limitation of dimensions of webs to be subjected to ultrasonic welding, as a displacement of the welding combination is foreseen, wherein any desired area may be covered. In practice, the welding combination may be moved in a direction which is perpendicular to a direction in which the web is moved through the device, so that the welding combination runs across the width of the web, which may be as large as desired in that case. This implies that the welding head and the anvil element are rotated a quarter turn with respect to the position these components are having in a conventional situation such as described in WO 95/13182, as they are oriented such as to treat the web in a direction perpendicular to its direction of movement, instead of a direction equal to its direction of movement.

In particular, in practice, an ultrasonic welding process according to the invention may involve the aspects as described in the following. The at least one web to be subjected to an ultrasonic welding process is positioned between the welding head and the anvil element, and is kept at a fixed position. The ultrasonic welding process is then performed by means of the welding combination, wherein the welding head is given an ultrasonic vibrating movement, and acts on small portions of the web which are locally supported by the anvils of the anvil element. In the process, the welding combination is displaced in order to perform an ultrasonic welding process on an area of the web which is as large as a rectangle defined by the width of the welding combination, and the length of the path along which the welding combination is displaced. When the welding combination has reached the end of its path, the web is made to move along a distance which is determined by the width of the welding combination. As soon as this movement has ended, the welding combination may be driven such as to perform an ultrasonic welding process on a new portion of the web, which is adjacent to a portion in which the web has been treated in a previous step. In the process, the welding combination moves in a backward direction with respect to a direction of movement of the previous step. Hence, by moving the welding combination back and forth, and moving the web in between the movements of the welding combination in the two opposite directions along a distance associated with the width of the welding combination, an ongoing ultrasonic welding process of the web may be realized.

It is also possible that the web is moved through the device during the ultrasonic welding process. In that case, the welding combination may perform a movement having a component which corresponds to the movement of the web. In other words, the welding combination may be moved with respect to the web as described in the foregoing, and may be moved in the device along with the web at the same time. In that case, when the welding combination has reached the end of its path across the web, the welding combination is displaced backward along a distance which is determined by a width of the welding head and the anvil element, in the direction in which the web is moved through the device. In the process, the movement of the web may be continued, but it is also possible that this movement is temporarily stopped during the time that the welding combination is displaced for the purpose of starting an ultrasonic welding process on a new portion of the web, which is adjacent to a portion in which the web has just been processed.

With respect to the anvil element, it is noted that this component of the welding combination may comprise a roller, wherein this roller is rotated about its longitudinal axis during the ultrasonic welding process and the associated displacement of the welding combination. With respect to the welding head, it is noted that this component of the welding combination may comprise at least two head units which are arranged in a row, in which are more or less separate units.

The ultrasonic welding method and device according to the invention may be used in any situation in which webs need to be joined, provided that the material of the webs is suitable for establishing mutual connections under the influence of a treatment with welding head and an anvil element as described in the foregoing. For example, the webs may be webs comprising polypropylene, but other materials are also feasible within the scope of the invention. The webs to be joined may be two webs, wherein a first web is a supporting web which is drawn from a roller, and wherein a second web is provided in the form of segments which are positioned on the supporting web in such a way as to completely cover the supporting web. However, numerous alternatives exist within the scope of the invention, wherein the number of webs may be two or more, and wherein the webs may be fully or only partly overlapping. For example, two or three supporting webs may be positioned adjacent to each other, wherein web segments having a length corresponding to a total width of the three supporting webs are used to cover the supporting webs.

The ultrasonic welding process may be used for providing an ultimate connection of webs, but may also be used in processes in which a mutual position of the webs is fixed first by performing an action aimed at interconnecting the webs to such an extent that the desired mutual fixation is actually obtained, and in which the webs are subsequently subjected to a process for establishing an ultimate connection, wherein the process may be any suitable known process such as a laminating process.

Also, the ultrasonic welding method and device according to the invention are suitable to be used for treating a single web, especially a nonwoven web, for the purpose of strengthening the web.

In the ultrasonic welding process according to the invention, in which both the welding head and the anvil element are displaced with respect to the at least one web to be treated, high accuracy of controlling the displacement process contributes to obtaining outstanding welding results. As the welding head and the anvil element are separated by the web during their use, and the web may have rather large dimensions, it is in many practical cases not possible to have a direct physical connection of the two components of the welding combination. In view of this, the invention proposes to apply servo techniques for driving the welding head and the anvil element, wherein the device according to the invention may be equipped with linear motors. As is generally known, servo techniques are based on the principle of negative feedback, wherein an actual position is measured and compared to a desired position. The outcome of the comparison is a difference between the actual position and the desired position, and this information is used to adjust the actual position, wherein the adjustment is aimed at decreasing the difference.

In the device according to the invention, which comprises the displaceable welding head and anvil element, guiding may be applied for letting both components move along a straight line. However, in practice, deviations are present in both movements, and there is a risk of incorrect mutual positioning of the components of the welding combination. According to the invention, in order to reduce this risk, it is envisaged to measure details of a displacement of the anvil element prior to first use of the device, and to store these details in a memory. In particular, the details may be deviations with respect to a straight line, wherein bending of the construction for supporting the elongated welding head, and the elongated anvil element may play a role. These details may then be used in the process of controlling the displacement of the welding head, wherein it is realized that the displacement of the welding head has the same errors as the displacement of the anvil element with respect to a straight line. In that case, it is ensured that a correct mutual position of the welding head and the anvil element is maintained under all circumstances, and that, consequently, the ultrasonic welding process may be performed in a most accurate manner without the need for very complex control measures. Within the scope of the invention, it is also possible to apply other principles of controlling the displacements of the components of the welding combination. For example, the displacement of the anvil element may be controlled on the basis of stored data relating to the way in which the welding head appears to move.

According to the invention, a welding combination for performing an ultrasonic welding process on at least one web is displaced during the welding process, in another direction than the direction of the ultrasonic vibrating movement of the welding head. In the process, the welding head and the anvil element, which are the two main components of the welding combination, are kept at the same effective mutual position, i.e. a mutual position in which the welding head and the anvil element are capable of cooperating in an suitable manner for realizing an ultrasonic welding process. For sake of completeness, it is noted the fact that the welding head and the anvil element are kept at the same effective mutual position should not be understood such as to mean that during the ultrasonic welding process, there are no changes of the mutual position of the welding head and the anvil element whatsoever. When the welding head and the anvil element are in the effective mutual position and are operated such as to perform an ultrasonic welding process, it is even necessary for changes in the mutual position of the welding head and the anvil element to take place, including changes which are caused at a small scale by the ultrasonic vibration of the welding head. Furthermore, the anvil element may be a roller which is rotated, but a change of the angular position of such roller is not to be regarded as constituting a change in the effective mutual position of the anvil element with respect to the welding head, as the ability of the welding head and the anvil element to perform an ultrasonic welding process is independent of the change of the angular position as mentioned.

According to one possibility existing within the scope of the invention, the welding combination may be moved back and forth across a web to be treated, i.e. from one side of the web to another, wherein the web is kept at its place during the time that the welding process is performed, and wherein the web is displaced over a distance which is related to the width of the welding combination at the time that the movement of the welding combination is reversed, so that adjacent portions of the web may be treated in an ongoing process.

Within the concept of moving the welding combination back and forth across at least one web to be treated, it is also possible that the web is moved during the time that the welding process is performed, wherein the welding combination is displaced backward over a distance which is related to the width of the welding combination, in the direction of the movement of the web and at the time that the movement of the welding combination is reversed, so that adjacent portions of the web may be treated in an ongoing process.

A most important advantage of the invention resides in the fact that there is no limit to the dimensions of the webs to be subjected to the ultrasonic welding process. Hence, a notable difference between the device according to the invention and devices according to the state of the art is that the device according to the invention may be suitable for conveying webs of which a dimension perpendicular to a direction in which the webs are to be conveyed through the device is larger than 3 metres. The invention offers a possibility of performing an ultrasonic welding process on webs having a width which is even larger than 3 metres, for example, larger than 6 metres, 8 metres, or 10 metres. In fact, as has been argued in the foregoing, there is no limitation whatsoever as to the dimensions of the webs. As far as the width of the welding head and the anvil element is concerned, it is noted that this may be a standard width, or a number of times a standard width, for example, 160 mm, 320 mm, or 480 mm; or 200 mm, 400 mm, or 600 mm.

In general, the device according to the invention is a device for performing an ultrasonic welding process on at least one web, comprising a combination of elongated welding head and an elongated anvil element, and means for realizing an ultrasonic vibrating movement of the welding head, wherein the combination of the welding head and the anvil element is displaceably arranged in the device, in a direction which is different from the direction for the ultrasonic vibrating movement of the welding head, and wherein means for realizing a displacement of the combination of the welding head and the anvil element in the said different direction are provided.

It is noted that U.S. Pat. No. 6,098,684 discloses an ultrasonic welding/cutting machine which includes an ultrasonic machining unit including a machining roller and a tool horn to which ultrasonic waves are transmitted. Both the machining roller and the tool horn are controlled such as to perform a reciprocating movement, wherein moving speeds of the machining roller and the tool horn are controlled such as to be equal. An important difference between the machine known from U.S. Pat. No. 6,098,684 and the device according to the invention relates to the shape of the machining roller and the tool horn, which is not an elongated shape. On the contrary, the machining roller is shaped like a disc, and the tool horn has a circular circumference.

The invention is in the field of elongated welding combinations, which are adapted to treat webs having considerable dimensions, whereas the welding combination known from U.S. Pat. No. 6,098,684 is only suitable to be used for joining webs having a relatively small width. Larger dimensions and elongated shapes involve larger weights and effects like bending of supporting constructions. The invention is in the field of such dimensions and shapes, wherein bending is an issue, and an application of standard calender roll principles is not possible.

In the device according to the invention, it is possible to have an arrangement of the welding combination in which the combination is movable in a direction which is different than the direction in which the web is to be conveyed through the device. For example, the direction of movement of the welding combination may be perpendicular to the direction of conveyance of the web, as has already been noted in the foregoing. In such a case, the welding head and the anvil element may be elongate in the direction of conveyance of the web, so that the ultrasonic welding process may be performed by moving the welding combination from one side of the web to another side, across the width of the device. It has already been remarked that this orientation of the welding combination is different than the orientation of the welding combination in conventional ultrasonic welding devices, wherein the difference is a quarter turn. However, it is also possible that the orientation of the welding combination is the same as in the conventional devices. In such a case, a total width of the web is covered by performing the ultrasonic welding process in the direction of conveyance of the web on adjacent portions of the web, wherein the welding combination is movable in a sideward direction, i.e. a direction in which the welding combination is elongate. When one portion of the web has been subjected to an ultrasonic welding process, the welding combination is moved to an adjacent portion as seen in the sideward direction, and the ultrasonic welding process can be performed on this portion as well. In the process, the welding combination may be moved in the direction of conveyance of the web, but it is also possible that only the web is moved and the welding combination is kept in place during the ultrasonic welding process, as is the case in conventional devices.

It is noted that it is also possible for the direction of movement of the welding combination in the device to have a component which is perpendicular to the direction of conveyance of the web. In such a case, another component of the direction of movement of the welding combination in the device may be the direction of conveyance of the web, in particular in the case in which the web is moved during the ultrasonic welding process.

The invention will now be explained in greater detail on the basis of the following description with reference to the figures, in which equal reference signs indicate equal or similar parts, and in which:

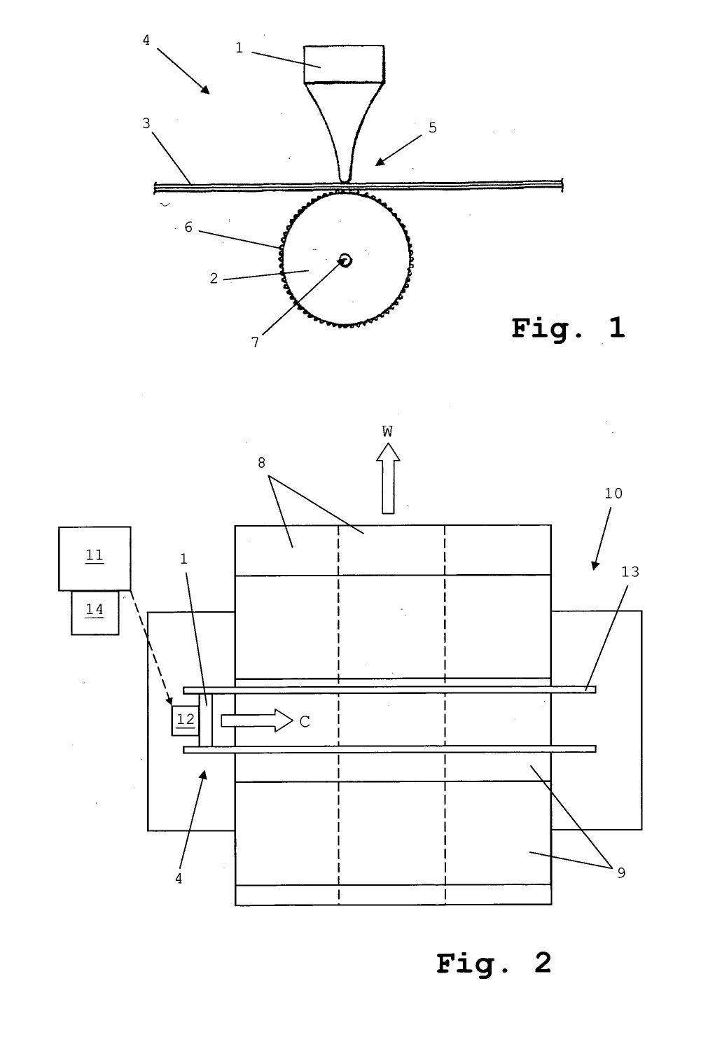

FIG. 1 serves to illustrate an ultrasonic welding process, and diagrammatically shows a welding head and an anvil roller which are used in the process, as well as a portion of two webs which are subjected to the process; and

FIG. 2 diagrammatically shows components of a device according to the invention and a portion of webs which are to be treated by means of the device, and serves to illustrate a first possibility of movements of the webs and a welding combination of the device;

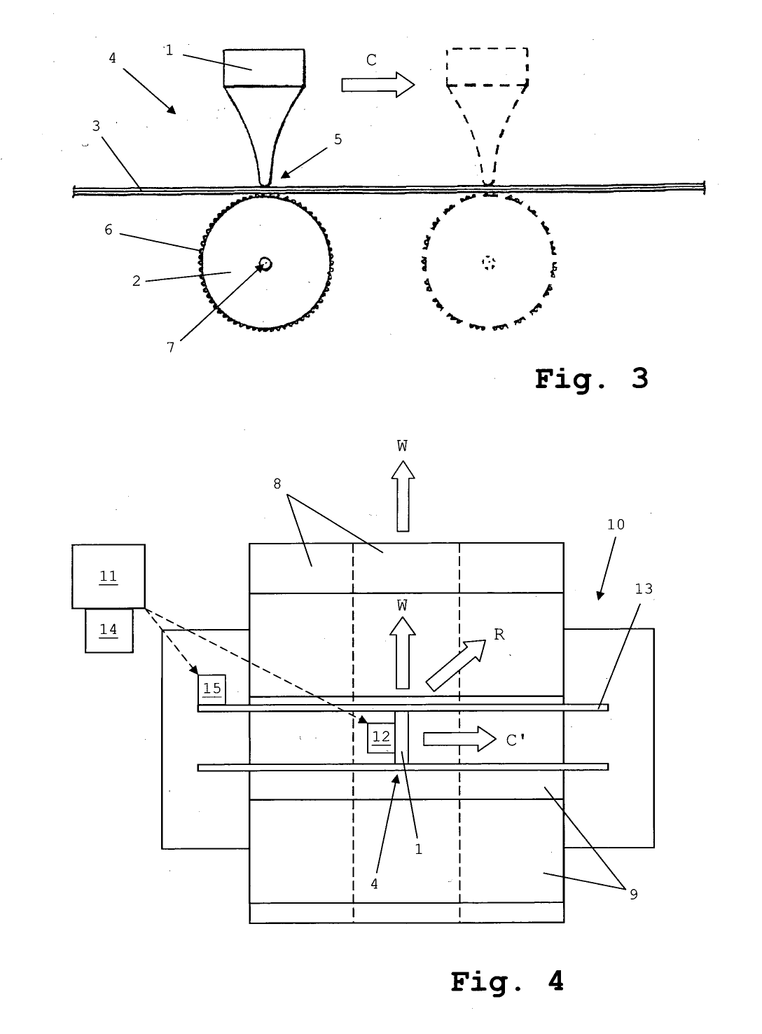

FIG. 3 diagrammatically shows two different positions of the welding combination in the device;

FIG. 4 diagrammatically shows components of a device according to the invention and a portion of webs which are to be treated by means of the device, and serves to illustrate a second possibility of movements of the webs and a welding combination of the device;

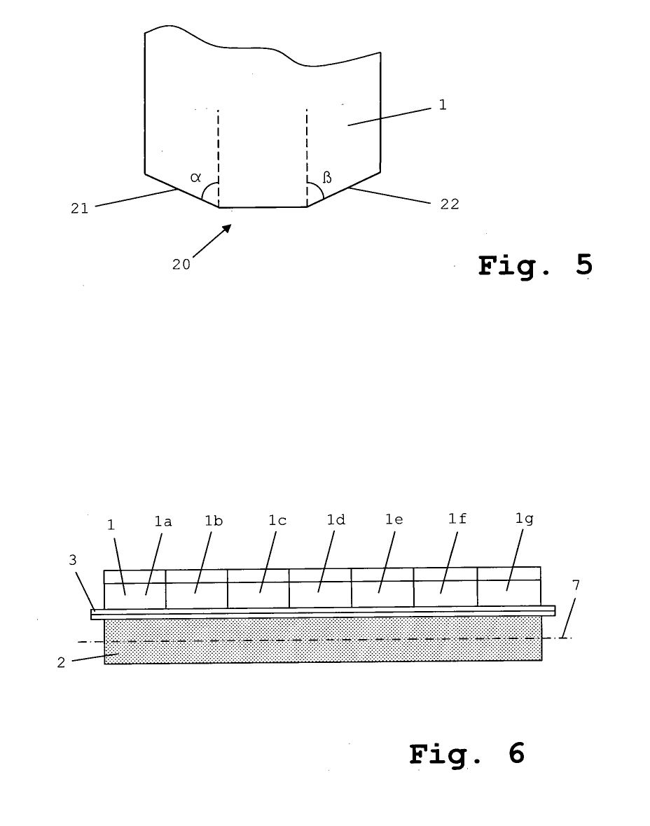

FIG. 5 diagrammatically shows a bottom portion of a welding head of a device according to the invention; and

FIG. 6 diagrammatically shows another view than FIG. 1 of a welding head, an anvil roller, and a portion of two webs which are positioned between the welding head and the anvil roller.

FIGS. 1 and 6 diagrammatically show a welding head 1 and an anvil roller 2 which are adapted to be used for performing an ultrasonic welding process on webs 3 which need to be joined. Both the welding head 1 and the anvil roller 2 have an elongated shape, as can be seen in FIG. 6, wherein the welding head 1 and the anvil roller 2 can have the same width. In the following, the combination of the welding head 1 and the anvil roller 2 will be referred to as welding combination 4. The technique of ultrasonic welding is known per se, and will therefore only be briefly explained here.

It is noted that in the shown example, the welding head 1 comprises a number of head units 1a, 1b, 1c, 1d, 1e, 1f, 1g, which are arranged in a closely adjoining fashion. The welding head 1 and the anvil roller 2 can be rather large, wherein rather heavy constructions for supporting the welding head 1 and the anvil roller 2 are required. For example, one head unit 1a, 1b, 1c, 1d, 1e, 1f, 1g may have a width of 160 mm, wherein the total width of the welding head 1 and the anvil roller is 1,120 mm. The invention provides for a possibility of using rather large and heavy components for processing webs 3 which are having even larger dimensions than the width as mentioned.

The welding head 1 and the anvil roller 2 are positioned with respect to each other in such a way that a narrow gap 5 is present in between. The webs 3 to be subjected to the ultrasonic welding process are positioned in this gap 5, i.e. between the welding head 1 and-the anvil roller 2. The welding head 1, which is also often denoted as welding horn, is adapted to be moved up and down in the material of the webs 3, while the anvil roller 2 comprises a suitable pattern of projections 6 which are adapted to act as anvils for the welding head 1 to slam on with a small portion of the webs 3 in between. The welding head 1 is driven by means (not shown) which are adapted to let the welding head 1 perform its up and down movement at an ultrasonic frequency.

In conventional ultrasonic welding devices, the arrangement of the welding combination 4 is fixed. During operation, the welding head 1 is moved up and down at the ultrasonic frequency as mentioned, the anvil roller 2 is rotated, and the webs 3 are moved through the gap 5. The rotational speed of the anvil roller 2 and the travelling speed of the webs 3 are adapted to each other in such a way that slip between the webs 3 and the anvil roller 2 does not occur. It will be clear that in this arrangement, a width of the welding combination 4 needs to be at least as large as a width of webs 3 to be treated.

According to the invention, the welding combination 4 is movably arranged. According to a feasible possibility existing within the scope of the invention, a direction in which the welding combination 4 is movable in a direction which is perpendicular to both the direction of the ultrasonic vibrating movement of the welding head 1 and the direction in which the longitudinal axis 7 of the anvil roller 2 is extending. In any case, the welding combination 4 may be made to move across an entire area of webs for performing an ultrasonic welding process, without limitations, wherein the area may have any size.

The way in which the invention works will further be explained on the basis of FIG. 2. By way of example, FIG. 2 diagrammatically shows three adjacent webs 8 and a number of web segments 9 which are positioned transversely to the webs 3 and which are to be connected to the three webs 8 by ultrasonic welding, and various components of a device 10 for performing the ultrasonic welding process. In the following, this device 10 will be referred to as welding device 10. A direction in which the webs 8 are conveyed through the welding device 10, in an adjoining fashion and in their longitudinal direction, is indicated by an arrow W in FIG. 2. It is noted that the width of each of the webs 8 may be in an order of 2 metres, for example, which does not alter the fact that other dimensions are also feasible within the scope of the invention. In any case, in the shown example, the length of the web segments 9 equals a total width of the three webs 8. Furthermore, it is noted that in FIG. 2, edges of the three webs 8 are indicated by means of a dashed line.

The welding device 10 comprises a welding combination 4 and control means 11 such as a microcontroller for controlling the operation of the welding combination 4 and other components. It is noted that only the welding head 1 of the welding combination 4 is shown in FIG. 2. Control signals of the control means 11 to displacement means 12 of the welding combination 4 are diagrammatically depicted by means of a dashed arrow.

Both the welding head 1 and the anvil roller 2, are displaceably arranged in the welding device 10, in a direction which is perpendicular to the direction W of conveyance of the webs 8 through the device 10. In FIG. 2, the direction in which the components of the welding combination 4 are displaceable is indicated by an arrow C. For sake of completeness, it is noted that this direction C is also perpendicular to a direction in which the welding head 1 is made to vibrate during operation of the welding device 10. The way in which the welding combination 4 is movable in the welding device 10 is further illustrated on the basis of FIG. 3, which shows a first position of the welding head 1 and the anvil roller 2 in continuous fines, and a second position in dashed lines, wherein the direction C of the movement is also shown. FIG. 3 provides a clear illustration of the fact that the welding head 1 and the anvil roller 2 perform the same movement along the webs 3 which need to be joined.

In a practical embodiment of the welding device 10 according to the invention, guides 13 are provided to guide the welding head 1 and the anvil roller 2 in their displacement across the webs 8 and the web segments 9. In view of the fact that the material to be welded is positioned between the welding head 1 and the anvil roller 2, it is required that the guides 13 extend at only one side of the welding device 10, wherein it is not possible to have supports for the guides 13 crossing from one side to the other, as such supports would be in the way of the material to be welded. The guides 13 are relatively long, wherein the length may be a considerable number of metres. Therefore, it is important for the guides 13 to be rigid and accurate to a large extent. Consequently, a manufacturing process of the guides 13 is a difficult process, and a process of tuning a displacement of the welding head 1 in its guide 13 on the one side, and a displacement of the anvil roller 2 in its guide 13 on the other side is useful in order to guarantee a most accurate mutual positioning of the welding head 1 and the anvil roller 2, as will be explained later. First, the way in which a process of ultrasonic bonding of the webs 8 and the web segments 9 positioned thereon takes place when the welding device 10 is applied will be described.

A process of ultrasonic bonding of the webs 8 and the web segments 9 positioned thereon may take place in various steps, which are continuously repeated. During operation of the welding device 10, the welding head 1 is driven such as to vibrate at an ultrasonic frequency. In a first step, the welding combination 4 is displaced from one side of the welding device 10 to another side of the welding device 10, wherein a first area of the webs 8 and the web segments 9 is covered and subjected to an ultrasonic welding process. The size of this area in the direction W of conveyance of the webs 8 is determined by a width of the welding combination 4. During the displacement of the welding combination 4, the anvil roller 2 is driven such as to rotate about its longitudinal axis 7. Furthermore, the webs 8 and the web segments 9 are kept at a fixed position, wherein suitable means (not shown) may be used to retain the webs 8 and the web segments 9. In this respect, reference is made to EP 1 719 609 and EP 2 039 493 in the name of applicant, which relate to methods of retaining webs and web segments.

In a second step, as soon as the welding combination 4 has reached the other side, the webs 8 and the web segments 9 positioned thereon are moved further through the welding device 10, over a limited distance which is also determined by the width of the welding combination 4. At that point, a new area is put in the position for undergoing an ultrasonic welding process.

In a-third step, the welding combination 4 is displaced again, and moves back to the position which may be denoted as initial position for the previous welding process. In the process, in the new area, which is adjacent to the previous area, bonding of the webs 8 and at least one web segment 9 is realized.

When the new area has been completely covered, the process of moving the webs 8 and the web segments 9 over a limited distance and subsequently letting the welding combination 4 run from one side to another is started again and continuously repeated. Thus, in this example, the ultrasonic bonding process is performed on the entirety of the webs 8 and the web segments 9 by alternately letting the welding combination 4 move in one direction C, which is perpendicular to the direction W of conveyance of the webs 8 through the welding device 10, and bringing a new area of the webs 8 and the web segments 9 within reach of the welding combination 4 by displacing the webs 8 and the web segments 9 over a certain length. In the process, the welding combination 4 moves back and forth, while the webs 8 and the web segments 9 only moves forth through the welding device 10.

The process of ultrasonic welding yields good bonding results if the mutual positioning of the welding head 1 and the anvil roller 2 is accurate during this process, as the anvils 6 of the anvil roller 2 need to be relatively small in order to realize the local heating effects as desired, and an end of the welding head 1 needs to strike the anvils 6 through the webs 8 and the web segments 9 in a predetermined manner. All in all, it is most desirable to have an accurate control of the displacements of both the welding head 1 and the anvil roller 2, wherein it is mainly their mutual position which should be accurately maintained.

Within the scope of the invention, various ways of controlling the displacement of the welding head 1 at one side of the webs 8 and the web segments 9, and the displacement of the anvil roller 2 on another side of the webs 8 and the web segments 9 exist. According to a preferred option, servo techniques are applied, and suitable means like linear motors are used for the purpose of driving the various components. It is also an advantageous option to take measures which are aimed at letting one of the welding head 1 and the anvil roller 2 follow the displacement of another of the welding head 1 and the anvil roller 2. For example, the displacement of the anvil roller 2 is accurately measured, wherein deviations with respect to an imaginary, perfectly straight line are found. When the welding device 10 is equipped with a memory 14 in which data regarding the displacement of the anvil roller 2 and the associated errors are stored, the control means 11 can be enabled to use these data in controlling the displacement of the welding head 1. Thus, it is possible to let the displacement of the welding head 1 be characterized by the same errors with respect to a straight line as the displacement of the anvil roller 2, so that a correct mutual position of the welding head 1 and the anvil roller 2 is maintained throughout the displacement process.

FIG. 4 illustrates alternative option for the movements of the webs 8 and the welding combination 4 during an ultrasonic welding process. According to this option, the webs 8 are not kept at a fixed position, but are moved in the direction W of conveyance of the webs 8 instead.

In a first step, the welding combination 4 is displaced from one side of the welding device 10 to another side of the welding device 10 in a direction C′, and is moved along with the webs 8 in the direction W of conveyance of the webs 8 at the same time, wherein a first area of the webs 8 and the web segments 9 is covered and subjected to an ultrasonic welding process. Hence, the movement of the welding combination 4 has two components, namely a component in the direction W of conveyance of the webs 8 and a component in the direction C′ from one side of the welding device 10 to another, straight across the webs 8 and the web segments 9. Hence, a resulting direction R of the movement of the welding combination in the welding device 10 is between the direction W of the conveyance of the webs 8 and the direction C′ of the movement straight across the webs 8 and the web segments 9 from one side of the welding device 10 to another, so that the resulting direction R may be denoted as an slanting direction in the welding device 10, as the welding combination 4 is not only moved forward, but sideward as well in order to follow the movement of the webs 8.

It is noted that besides displacement means 12 for displacing the welding combination 4 in the direction C′ from one side of the welding device 10 to another, across the webs 8 and the web segments 9, and with respect to the guides 13, displacement means 15 for displacing the guides 13 in the direction W of conveyance of the webs 8 are diagrammatically shown as well in FIG. 4. Furthermore, control signals of the control means 11 to these additional displacement means 15 are diagrammatically depicted by means of a dashed arrow, like the control signals of the control means 11 to the displacement means 12 of the welding combination 4 in the guides 13.

In a second step, as soon as the welding combination 4 has reached the other side, the welding combination 4 is made to perform a backward movement in the direction W of conveyance of the webs 8, over a limited distance which is also determined by the width of the welding combination 4. At that point, the welding combination 4 is in a position for subjecting a new area of the webs 8 and the web segments 9 to an ultrasonic welding process. During the time that the welding combination 4 performs the backward movement as mentioned, the webs 8 may continue their movement, but it is also possible that this movement is temporarily interrupted until the welding combination 4 has reached a new position for performing a next stroke in the ultrasonic welding process.

In a third step, the welding combination 4 is displaced again, wherein the displacement takes place in a reversed direction. When the welding combination 4 reaches the other side again, a fourth step takes place, during which the above-described process of moving the welding combination backward in the direction W of conveyance of the webs 8 is performed again, so that the welding combination 4 is in a position for performing a next stroke in the ultrasonic welding process. The movements of the welding combination 4, resulting from moving back and forth from one side of the welding device 10 to another while moving along with the webs 8 as well are repeated as long as necessary for bonding a desired length of the webs 8 and a desired number of web segments 9.

FIG. 5 shows a view of a bottom portion of a possible embodiment of a welding head 1 for use in a welding device 10 according to the invention. In conventional welding devices 10, the welding head 1 is not displaced across the webs 3, 8, 9 to be joined, and the welding head 1 is approached by the webs 3, 8, 9 from only one side, namely the side from which the webs 3, 8, 9 are fed. In many cases, a surface of the welding head 1 facing the anvil roller 2 is provided with a position which is to some extent deviant from a perpendicular position with respect to the direction of the ultrasonic movement of the welding head 1, wherein a highest edge of the surface is present at the side of the welding head 1 which is approached by the webs 3, 8, 9.

In the welding device 10 according to the invention, the welding head 1 approaches the webs 3, 8, 9 during an ultrasonic welding process, wherein the approach may take place at either one of two edges of the welding head 1 in case the welding combination 4 is made to perform a back and forth movement as described on the basis of FIGS. 2 and 4. In view of this fact, the surface 20 of the welding head 1 facing the anvil roller 2 may have two edge portions 21, 22, which are each at an angle with respect to the direction of the ultrasonic vibrating movement of the welding head 1. In particular, the edge portions 21, 22 may be oriented according to similar angles (α, β), as seen from opposite directions, so that the way in which the webs 3, 8, 9 are approached by the welding head 1 is the same for every movement of the welding head 1, be it forward or backward from one side of the welding device 10 to another. In general, the surface 20 of the welding head 1 may have a mirror-symmetrical appearance, as is the case with the example as shown in FIG. 5.

It will be clear to a person skilled in the art that the scope of the invention is not limited to the examples discussed above, but that several amendments and modifications thereof are possible without deviating from the scope of the invention as defined in the appended claims.

It should be understood that the welding device 10 according to the invention may have many more components and features than those described in the foregoing, in particular components and features known from conventional welding devices, such as means for guiding the webs 8 and the web segments 9 positioned thereon through the device 10, and means for adjusting a size of the gap 5 between the welding head 1 and the anvil roller 2, during a welding process and/or beforehand, as known from DE 4439284, for example. However, omission of a description of such components and features is justified in view of the fact that they are not directly related to the invention.

In respect of an application of the invention for joining at least two webs 3, 8, 9, it is noted that these may be of any type that is suitable to be connected through ultrasonic welding. For example, the webs 3, 8, 9 to be processed by the welding device 10 according to the invention may be foils, nonwovens, UD (UniDirectional) sheets, and crossply sheets, wherein any desired and practical combination can be made. In particular, the invention provides a solution in the field of welding nonwoven material by using ultrasonic techniques, as it is not possible to connect large sheets of nonwoven material in conventional ultrasonic welding devices.

In the foregoing, a device 10 has been disclosed, which is adapted to perform an ultrasonic welding process on at least one web 3, 8, 9 by means of an elongated welding combination 4, i.e. a combination of an elongated welding head 1 and an elongated anvil element 2. In the device 10, the welding combination 4 is movably arranged, and means for realizing a displacement of the welding combination 4 are provided. According to a feasible possibility, the welding combination 4 is displaceable in a direction C, C′ which is perpendicular to a direction W of conveyance of the web 3, 8, 9 through the device 10. During the displacement process, the displacements of both the welding head 1 and the anvil element 2 are accurately controlled, so that the effective mutual position of these components of the welding combination 4 is maintained. An important advantage of the displaceable arrangement of the welding combination 4 is that there is no limit to a width of webs 3, 8, 9 to be treated.

1. Method for performing an ultrasonic welding process on at least one web comprising:
providing a device comprising a combination of an elongated welding head and an elongated anvil element;
positioning the web between the welding head and the anvil element;
ultrasonically vibrating the welding head while the welding head and the anvil element are in an effective mutual position for performing the ultrasonic welding process wherein a relative movement of the web on the one hand and the combination of the welding head and the anvil element on the other hand is realized; and
moving the combination of the welding head and the anvil element in the device during the ultrasonic welding process, in a direction which is different from the direction in which the ultrasonic vibrating movement of the welding head takes place, wherein the effective mutual position of the welding head and the anvil element is maintained at the same time.

2. Method according to claim 1, wherein a direction in which the combination of the welding head and the anvil element is moved with respect to the web during the ultrasonic welding process deviates from a direction in which the web is conveyed through the device.

3. Method according to claim 2, wherein the direction in which the combination of the welding head and the anvil element is moved with respect to the web during the ultrasonic welding process is perpendicular to the direction in which the web is conveyed through the device.

4. Method according to claim 1, wherein the web is moved through the device during the ultrasonic welding process and the associated movement of the combination of the welding head and the anvil element.

5. Method according to claim 1, wherein the web is kept at a fixed position in the device during the ultrasonic welding process and the associated movement of the combination of the welding head and the anvil element.

6. Method according to claim 1, wherein the combination of the welding head and the anvil element is continuously moved back and forth from an edge of the web to an opposite edge.

7. Method according to claim 6 further comprising continuously displacing the combination of the welding head and the anvil element along a distance which is related to a width of the welding head and the anvil element, in a direction in which the web is conveyed through the device, when the combination of the welding head and the anvil element is located at an edge of the web and its movement with respect to the web is reversed.

8. Method according to claim 6 further comprising continuously displacing the web along a distance which is related to a width of the welding head and the anvil element when the combination of the welding head and the anvil element is located at an edge of the web and its movement with respect to the web is reversed.

9. Method according to claim 1 further comprising rotating a roller of the anvil element about its longitudinal axis during the ultrasonic welding process and the associated movement of the combination of the welding head and the anvil element.

10. Method according to claim 1 further comprising using data regarding a displacement of the anvil element in a subsequent displacement of the combination of the welding head and the anvil element to provide the welding head with a movement which accurately follows the movement of the anvil element.

11. Method according to claim 1 further comprising controlling the movements of the combination of the welding head and the anvil element on the basis of servo techniques.

12. Method according to claim 1 further comprising applying the at least one web as one or more of a foil, a nonwoven, a UD sheet, a crossply sheet and a combination thereof.

13. Device for performing an ultrasonic welding process on at least one web, comprising:
a combination of an elongated welding head and an elongated anvil element;
ultrasonic vibrating means for realizing an ultrasonic vibrating movement of the welding head; and
displacement means for realizing a displacement of the combination of the welding head and the anvil element;
wherein the combination of the welding head and the anvil element is displaceably arranged in the device, in a direction which is different from the direction for the ultrasonic vibrating movement of the welding head.

14. Device according to claim 13, wherein the direction in which the combination of the welding head and the anvil element is displaceable deviates from a direction in which a web to be subjected to the ultrasonic welding process is conveyable through the device.

15. Device according to claim 14, wherein the direction in which the combination of the welding head and the anvil element is displaceable is perpendicular to the direction in which a web to be subjected to the ultrasonic welding process is conveyable through the device.

16. Device according to claim 14, wherein the direction in which the combination of the welding head and the anvil element is displaceable has a component which is perpendicular to the direction in which a web to be subjected to the ultrasonic welding process is conveyable through the device.

17. Device according to claim 13 further comprising a control which is adapted to provide the combination of the welding head and the anvil element with a reciprocating movement, through the displacement means.

18. Device according to claim 17 further comprising a memory in which data regarding a displacement of the anvil element are stored; and
wherein the control is adapted to access the memory, and to use the stored data for the purpose of controlling the displacement means in order to realize an accurate adaptation of a movement of the welding head to a movement of the anvil element.

19. Device according to claim 13, wherein the displacement means comprise linear motors.

20. Device according to claim 13, wherein the anvil element comprises a roller which is rotatably arranged about its longitudinal axis, and wherein means are provided for rotating the anvil element about its longitudinal axis.

21. Device according to claim 13, suitable for conveying at least one web of which a dimension perpendicular to a direction in which the web is conveyable through the device is larger than three meters.

22. Device according to claim 13, wherein a surface of the welding head facing the anvil element comprises two edge portions which are each at an angle with respect to the direction of the ultrasonic vibrating movement of the welding head.

23. Device according to claim 22, wherein the angle of one of the edge portions is equal to the angle of another of the edge portions, as seen from opposite directions.

24. Device according to claim 22, wherein the surface of the welding head facing the anvil element has a mirror-symmetrical appearance.

25. Method according to claim 10, wherein the data regarding a displacement of the anvil element comprises deviations with respect to a perfectly straight line.

26. Device according to claim 18, wherein the data regarding a displacement of the anvil element comprises deviations with respect to a perfectly straight line.
